(19) United States
(12) Patent Application Publication
(10) Pub. No.: US 2017/0163903 A1
(43) Pub. Date: Jun. 8, 2017

(54) METHOD AND ELECTRONIC DEVICE FOR PROCESSING IMAGE

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventors: Wenfeng Wang, Beijing (CN); Sixiang LIU, Beijing (CN)

(21) Appl. No.: 15/245,090

(22) Filed: Aug. 23, 2016

Related U.S. Application Data
(63) Continuation of application No. PCT/CN2016/088967, filed on Jul. 6, 2016.

(30) Foreign Application Priority Data
Dec. 8, 2015 (CN) 201510898226.2

(51) Int. Cl. H04N 5/262; H04N 5/77; H04N 5/232

(52) U.S. Cl. CPC H04N 5/2621; H04N 5/23222; H04N 5/23216; H04N 5/772; H04N 5/23293

(57) ABSTRACT

The present disclosure provides a method and a device for processing image. The method includes: determining, based on a target exposure time and a hardware supporting exposure time, a number of base-exposure images for synthesizing which a long-time exposure image; capturing the number of base-exposure images according to the hardware supporting exposure time; and synthesizing processing, based on association relationships of ambiguities of pixel points of corresponding positions of the base-exposure images, of the base-exposure images to generate the long-time exposure image corresponding to the target exposure time.

### CROSS-REFERENCE TO RELATED APPLICATIONS

This application is a continuation application of an international application No. PCT/CN2016/088967, filed on Jul. 6, 2016; and claims the priority of Chinese Patent Application No. 201510898226.2 entitled “Method and Device for processing image” and filed with the State Intellectual Property Office of China (SIPO) on Dec. 8, 2015, the contents of which are incorporated herein by reference in their entireties.

### TECHNICAL FIELD

Embodiments of the present disclosure relate to technologies of image processing, for example, relate to a method and an electronic device for processing image.

### BACKGROUND

As cameras have been more and more widely used in various electronic devices, the demand of user's experience for photographing is unceasingly increasing.

Images with special display effect may be obtained through photographing with long-time exposure, so it is concerned by users. Photographing with long-time exposure means a photographing mode in which the exposure time is relatively long, and the photographing with long-time exposure is realized by maintaining a shutter in on-state for a long time. Typically, an exposure having an exposure time greater than 1 second is called a long-time exposure. In related technologies, a method for obtaining a long-time exposure image is to set exposure time for a photographing device and complete image capturing by one time within the set exposure time in a manual operation manner.

During realization of the present disclosure, the inventors found that long-time exposure usually requires hardware support of sensors itself in the photographing devices for realization, while a large number of sensors of existing photographing devices do not support long-time exposure or only support short-time exposure, resulting in that users can't obtain satisfactory images, and influencing the user's photographing experience.

### SUMMARY

The present disclosure provides a long-time exposure photographing method and an electronic device for long-time exposure photographing, by which images with good light trace effects can be obtained.

According to a first aspect, embodiments of the present disclosure provide a method for processing image. The method includes:

determining, based on a target exposure time and a hardware supporting exposure time, the number of base-exposure images for synthesizing a long-time exposure image;

capturing the number of base-exposure images according to the hardware supporting exposure time;

synthesizing processing, based on association relationships of ambiguities of pixel points of corresponding positions of the base-exposure images, of the base-exposure images to generate the long-time exposure image corresponding to the target exposure time.

According to a second aspect, embodiments of the present disclosure further provide an electronic device for processing image. The electronic device includes at least one processor and a memory. Instructions executable by the at least one processor may be stored in the memory. Execution of the instructions by the at least one processor causes the at least one processor to:

determine, based on a target exposure time and a hardware supporting exposure time, the number of base-exposure images for synthesizing a long-time exposure image;

capture the number of base-exposure images according to the hardware supporting exposure time;

synthesizing process, based on association relationships of ambiguities of pixel points of corresponding positions of the base-exposure images, of the base-exposure images to generate the long-time exposure image corresponding to the target exposure time.

According to a third aspect, embodiments of the present disclosure further provide a non-volatile memory storage medium, storing executable instructions that, when executed by an electronic device, cause the electronic device to:

determine, based on a target exposure time and a hardware supporting exposure time, the number of base-exposure images for synthesizing a long-time exposure image;

capture the number of base-exposure images according to the hardware supporting exposure time; and

synthesizing process, based on association relationships between ambiguities of pixel points of corresponding positions of the base-exposure images, of the base-exposure images to generate the long-time exposure image corresponding to the target exposure time.

### BRIEF DESCRIPTION OF THE DRAWINGS

At least one embodiment is illustrated by way of example, and not by limitation, in the figures of the accompanying drawings, wherein elements having the same reference numeral designations represent like elements throughout. The drawings are not to scale, unless otherwise disclosed.

FIG. 1 is a schematic flowchart of a method for processing image according to embodiments of the present disclosure;

FIG. 2A is a schematic flowchart of a method for processing image according to embodiments of the present disclosure;

FIG. 2B is a schematic view of a base-exposure image according to embodiments of the present disclosure;

FIG. 2C is a schematic view of an operated image according to embodiments of the present disclosure;

FIG. 2D is a schematic view of a new image by combining the image in FIG. 2B with the image in FIG. 2C according to embodiments of the present disclosure;

FIG. 3 is a schematic view showing the structure of a device for processing image according to embodiments of the present disclosure; and

FIG. 4 is a schematic view showing the hardware structure of an electronic device according to embodiments of the present disclosure.

### DETAILED DESCRIPTION

The present disclosure will be further described in detail below in conjunction with accompanying drawings and embodiments. It should be understood that the embodiments described herein are merely used for explaining the present disclosure, but not limiting the present disclosure. In addition, it is also noted that, for easy of description, relevant parts, rather than all parts, related to the present disclosure are shown in the accompanying drawings. Before describing exemplary embodiments in more detail, it should be noted that, some exemplary embodiments are described as processes or methods which are depicted by flowcharts. Although a flowchart may describe each operation (or procedure) as a sequential process, many of the operations may be performed in parallel, concurrently, or simultaneously. Moreover, the order of the operations may be re-arranged. A process terminates when its operations are completed, but could have additional steps not included in the accompanying drawings. The process may correspond to a method, a function, a procedure, a subroutine, a subprogram, etc.

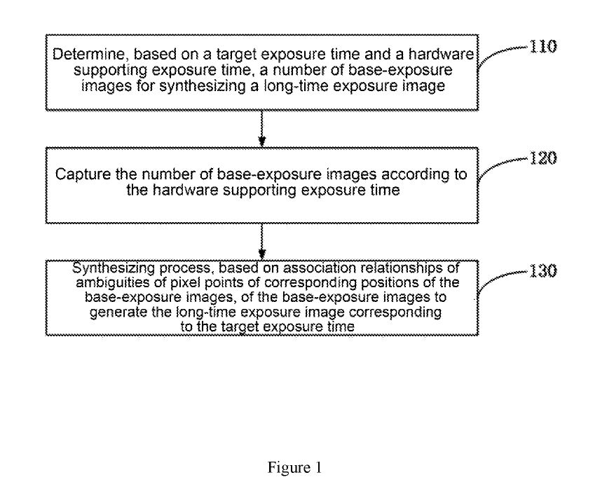

FIG. 1 is a schematic flowchart of a method for processing image according to embodiments of the present disclosure. The present embodiment may be adapted for capturing an image with good light trace. The method for processing the image may be executed by a device for processing image. The device may be implemented in software and/or hardware manner, and generally may be integrated into an apparatus that supports image capturing.

Referring to FIG. 1, the method for processing image according to the present embodiment includes: step 110, step 120 and step 130.

In step 110, the number of base-exposure images, for synthesizing a long-time exposure image, is determined based on a target exposure time and a hardware supporting exposure time.

The target exposure time is set by a user and is used for determining a total exposure time required for a capturing device during obtaining the long-time exposure image (i.e. an image with good light trace). The target exposure time may be set according to desired effects achieved by the long-time exposure image. The hardware supporting exposure time specifically refers to a single-exposure time supported by the hardware of the photographing device, and the image captured according to the hardware supporting exposure time is the base-exposure image.

Generally, an image capturing device can support a plurality of single-exposure times. In practical application, an exposure time that meets the requirement may be selected as the hardware supporting exposure time. For example, a maximum exposure time in the plurality of single-exposure times supported by the hardware of the image capturing device is selected as the hardware supporting exposure time, or the exposure time with best exposure performance in the plurality of single-exposure times is selected as the hardware supporting exposure time. The present embodiment is not limited thereto.

Since the hardware supporting exposure time is limited by the hardware of the photographing device, the photographing device with common configuration generally has a relatively short exposure time, and images captured by the photographing device do not have good light trace. In the present embodiment, under a background image synthesizing mode, long-time exposure images with good light trace are obtained by employing photographing devices the hardware of which supports a relative shorter exposure time. According to embodiments of the present disclosure, the photographing device continuously captures a plurality of base-exposure images until an accumulated exposure time is equal to a target exposure time. The plurality of base-exposure images are synthesized together in a preset mode to obtain the long-time exposure image.

Illustratively, determining, based on a target exposure time and a hardware supporting exposure time, the number of base-exposure images by synthesizing which a long-time exposure image is obtained may include following steps: determining the target exposure time M based on operation of a user; acquiring a maximum exposure time supported by hardware as the hardware supporting exposure time N; determining, based on a formula k=┌M/N┐, the number k of the base-exposure images for synthesizing the long-time exposure image, where M>N, and ┌•┐ represents a round-up operation.

It should be noted that, the target exposure time may be an integral multiple of the hardware supporting exposure time, and may also be a non-integral multiple of the hardware supporting exposure time. In a case that the target exposure time is an integral multiple of the hardware supporting exposure time, a ratio of the target exposure time to the hardware supporting exposure time is the number of photographing times required for the photographing device during obtaining the long-time exposure image, and correspondingly is the number of the base-exposure images. In a case that the target exposure time is a non-integral multiple of the hardware supporting exposure time, the ratio of the target exposure time to the hardware supporting exposure time is not an integer, the value of the integer portion of the ratio is the number of photographing times carried out by the photographing device for the hardware supporting time, and the exposure time for the last photographing is less than the hardware supporting exposure time, but a photographing operation is still required to be performed by the photographing device. Therefore, in this case, the number of photographing times performed by the photographing device during obtaining the long-time exposure image is a sum of one and the integer portion of the ratio, and the number of corresponding base-exposure images is also a sum of one and the integer portion of the ratio.

In step 120, the number of base-exposure images are captured according to the hardware supporting exposure time.

In order to obtain a long-time exposure image with good light trace, the target exposure time is greater than the hardware supporting exposure time, the photographing device should require photographing at least two times according to the hardware supporting exposure time, and accordingly obtain at least two base-exposure images. As mentioned above, the specific number of the base-exposure images is determined by the ratio of the target exposure time to the hardware supporting exposure time.

In step 130, the base-exposure images are synthesizing processed, based on association relationships of ambiguities of pixel points of corresponding positions in the base-exposure images, to generate the long-time exposure image corresponding to the target exposure time.

Pixel point of corresponding position specifically means pixel points having the same coordinates in two base-exposure images that will be synthesized. Combination process is performed on two images to be combined. In a case that only two base-exposure images are existed, each of the two base-exposure images is an image to be combined, the long-time exposure image can be obtained by combining the two images to be combined. In a case that the number of base-exposure images is greater than two, each of the base-exposure images is sequentially combined in a superimposing manner according to the order for obtaining the base-exposure images. Therefore, two base-exposure images are used in the first step of the synthesizing process, while two images to be combined in each of steps, excluding the first step, of the synthesizing process include a base-exposure image and a synthesized image in the previous step.

When a synthesizing process is performed on two images to be synthesized, pixel points in the two images to be synthesized are simultaneously scanned. The specific scanning mode to pixel points is not limited by the present embodiment. The pixel points may be scanned from left to right in a line by line scanning mode, or the pixel points may also be scanned in a one-stop mode. It should be noted that, in order to improve the processing efficiency, it is arranged that pixel points of corresponding positions in two images are scanned simultaneously and ambiguities of pixel points of corresponding positions are calculated. Illustratively, a manner for calculating the ambiguity of a pixel point may be to solve Laplace's response in time-domain or compare high-frequency components in frequency-domain. Then the relationship between ambiguities of pixel points of corresponding positions is calculated, and it is determined, based on a comparison result, that the pixel points of which one of the images to be processed are used to fill pixel points of corresponding positions in a synthesized image, thereby obtaining the synthesized image.

Each of the base-exposure images is synthesizing processed according to above superimposing manner to generate the long-time exposure time corresponding to the target exposure time.

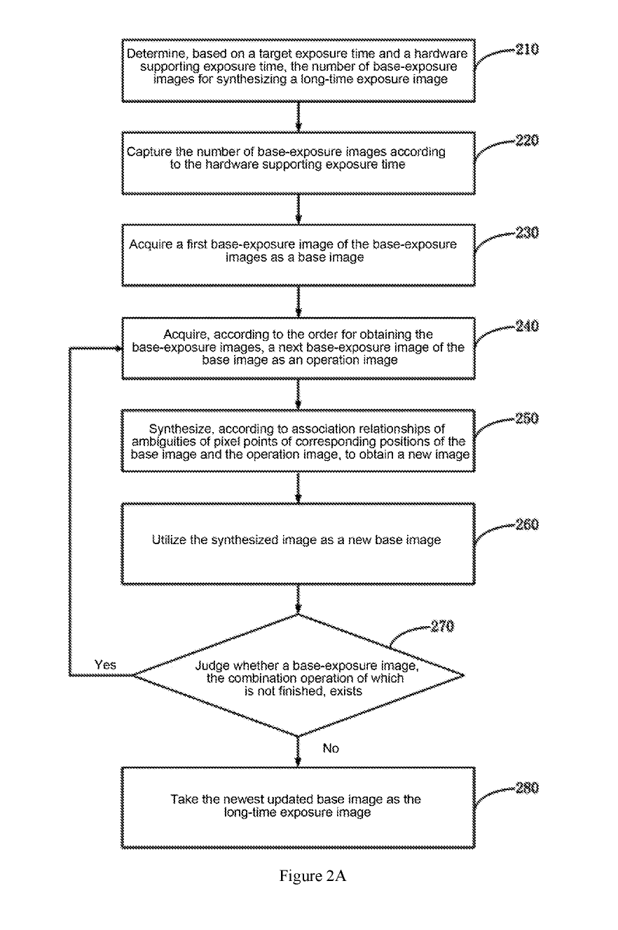

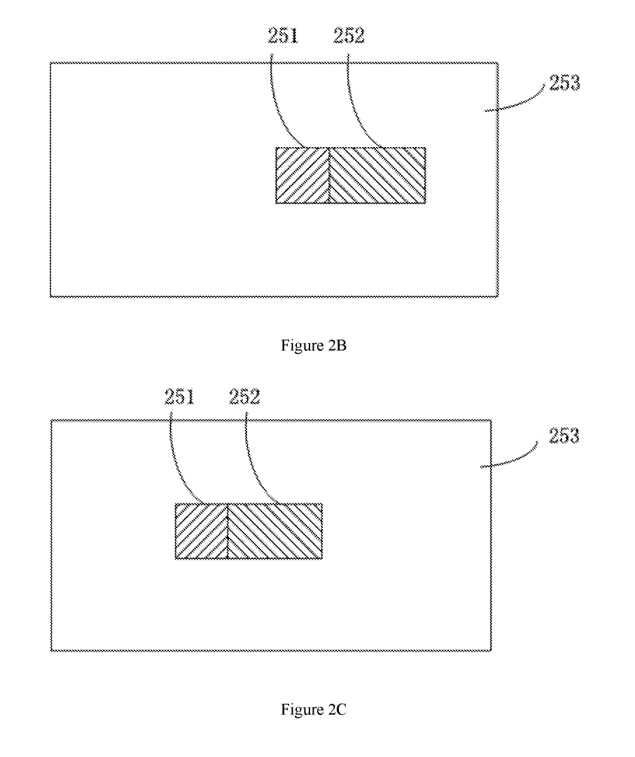

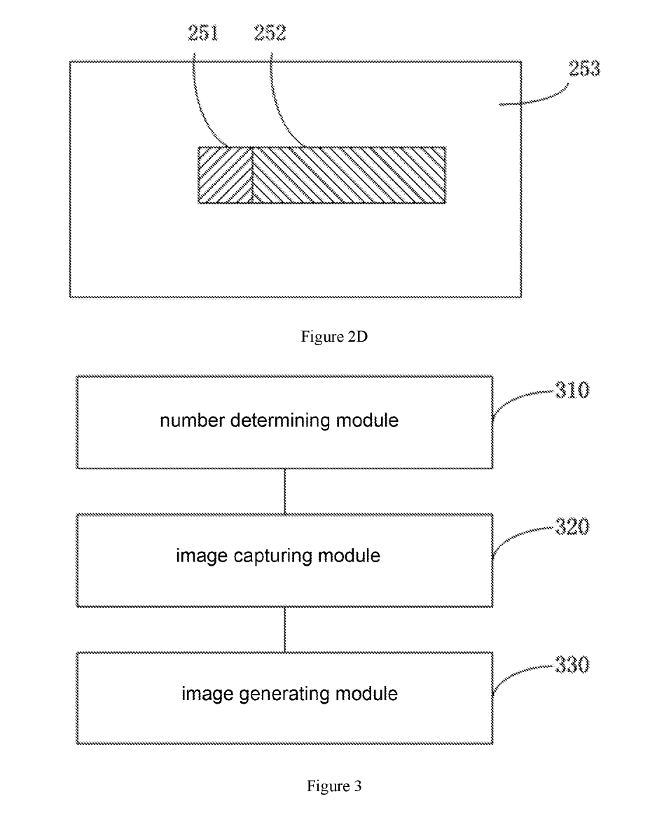

According to the technical solution provided by the present embodiment, through determining, based on the target exposure time and hardware supporting exposure time, the number of base-exposure images; capturing the number of base-exposure images, the number of which is greater than two; and synthesizing, based on association relationships of ambiguities of pixel points of corresponding positions of the base-exposure images, the base-exposure images to generate the long-time exposure image, it is possible that an image with long-time exposure effect is obtained by utilizing a device that supports short-time exposure, and hence the restriction of the hardware of photographing device on image effect is reduced, thereby improving the user's experience. A method for processing image is provided according to the present embodiment on the basis of aforementioned embodiments. FIG. 2A is a schematic flowchart of a method for processing image according to embodiments of the present disclosure. As illustrated in FIG. 2A, the method for processing image according to the present embodiment includes: step 210 to step 280.

In step 210, the number of base-exposure images for synthesizing a long-time exposure image, is determined based on a target exposure time and a hardware supporting exposure time. The number of base-exposure images for synthesizing a long-time exposure image, is greater than or equal to two.

In step 220, the number of base-exposure images are obtained according to the hardware supporting exposure time.

In step 230, a first base-exposure image of the base-exposure images is acquired as a base image.

The operation objects for the synthesizing process are two images to be synthesized. A first one, which is obtained earlier, of the two images to be synthesized is the base image and serves as a reference image in the synthesizing process operation. According to present embodiment, the base-exposure images are synthesized according to the order for obtaining the base-exposure images, and the first one of the base-exposure images serves as a first base image.

In step 240, according to the order for obtaining the base-exposure images, a next base-exposure image of the base image is used as an operation image.

The operation image is one of the two operation objects of a synthesizing process, the other one of the two operation objects of a synthesizing process is the base image. The next base-exposure image of the base image is acquired as the operation image so as to sequentially synthesize respective base-exposure image in a superimposing manner according to the order for obtaining the base-exposure images. For instance, according to the order for obtaining the base-exposure images, in the case that the first base-exposure image serves as the base image, the second base-exposure image is acquired as the operation image.

In step 250, a new image is formed by synthesizing according to association relationships of ambiguities of pixel points of corresponding positions of the base image and the operation image.

According to a scanning order, the ambiguity of pixel point of each corresponding position of the base image and the operation image is sequentially calculated, association relationships of the ambiguities of respective pixel points of corresponding positions are obtained simultaneously, and a pixel filling condition of the new image is determined according to the association relationship.

In some embodiments, forming the new image by synthesizing process according to the association relationships between ambiguities of pixel points of corresponding positions of the base image and the operation image may specifically include: sequentially scanning the base image and operation image; comparing the ambiguities of respective pixel points having the same coordinate positions in the base image and the operation image; if a difference between the ambiguities of the base image and the operation image which correspond to a same target coordinate position is less than or equal to a threshold value, taking a pixel point of the target coordinate position in the operation image as the pixel point of the target coordinate position in the synthesized image; if the difference between the ambiguities of the base image and the operation image which correspond to a same target coordinate position is greater than the threshold value, then taking a pixel point having a higher ambiguity as the pixel point of the target coordinate position in the synthesized image.

Ambiguity of the base image and ambiguity of the operation image, which correspond to a same target coordinate position specifically refer to ambiguity of pixel points having same coordinate in the base image and the operation image.

The basic principle used in the aforementioned image synthesizing process is below: during one single exposure photographing process performed by the photographing device, since the position of a stationary object remains unchanged, there is adequate time to focus, therefore, the ambiguity of the captured image is low. Accordingly, since the position of a moving object is varying, the captured image may record images of the moving object at all positions during the exposure time period. However, since a focus time corresponding to each position is very short, in the finally captured image, except that the moving object only appears at a position where the moving object is located at exposure terminating moment, a light trace appears at other positions through which the moving object passed, and ambiguity of the moving object and ambiguity of the light trace are high in the captured image. In summary, it can be concluded that, the definition of a moving object is lower than the definition of a stationary object during an image capturing process with long-time exposure. Accordingly, through comparing the ambiguities having a same target coordinate position in two images and performing a certain synthesizing process, an image the exposure time of which is 2p is obtained by synthesizing two images the exposure time of each of which is p, where p>0.

Scanning pixel points at a corresponding position in the base image and the operation image is taken as an example to describe a filling process of pixel point at the corresponding position in the new image formed by synthesizing process, and the filling process of pixel points of other position is also same.

Illustratively, pixel points having a first coordinate in the base image and the operation image are scanned and acquired, and the ambiguity of each of the pixel points in the first coordinate is calculated respectively, ambiguity A of pixel point, located at the base image's first coordinate O1, is obtained and ambiguity B of pixel point, located at the operation image's first coordinate O2, is obtained. If a difference between A and B is less than or equal to a threshold value, it means that the values of A and B are very close to each other, therefore, it means that both O1 and O2 correspond to a stationary entity or both O1 and O2 correspond to a moving entity (wherein the moving entity includes a moving object and a light trace formed by the moving object). In the present case, pixel point at the corresponding position of the new image obtained by synthesizing process is filled by pixel point located at the operation image's first coordinate O2. If the difference between A and B is greater than the threshold, it means that there is a large difference between the values of A and B, therefore, it means that one of O1 and O2 corresponds to a stationary entity and the other of O1 and O2 corresponds to a moving entity. To synthesizing light traces in two images for prolonging exposure time, pixel point with larger ambiguity from O1 and O2 is used to fill the pixel point at corresponding position of the new synthesized image.

FIG. 2B is a schematic view of a base-exposure image according to embodiments of the present disclosure; FIG. 2C is a schematic view of an operation image according to embodiments of the present disclosure; FIG. 2D is a schematic view of the new image, according to embodiments of the present disclosure, obtained by synthesizing the image in FIG. 2B and the image in FIG. 2C. Positions of an image of a moving object 251, a light trace 252, and an image of a stationary objective 253 in the above-mentioned three Figures are illustrated. It can be seen that the light trace 252 of the new image has synthesized the light trace of the base image and the light trace of the operation image.

In step 260, the synthesized image is utilized as a new base image, and step 270 is executed.

In step 270, it is judged whether a base-exposure image, the combination operation of which is not finished, exists. If the base-exposure image has not been synthesized, step 240 is executed; if the base-exposure image has been synthesized, step 280 is executed.

In step 280, the newest updated base image is used as the long-time exposure image.

In the present embodiment, according to the order for obtaining the base-exposure images, each of the base-exposure images is sequentially synthesized in a superimposing manner. Optionally, the first base-exposure image is acquired as a base image, the second base-exposure image is acquired as an operation image, and a new image is obtained, by synthesizing processing the first base-exposure image and the second base-exposure image, as a first synthesized image. Then, the first synthesized image is taken as a base image, the third base-exposure image is acquired as an operation image, a new image is obtained, by synthesizing processing the first synthesized image and the third base-exposure image, as a second synthesized image. Then, the second synthesized image is taken as a base image, the fourth base-exposure image is acquired as an operation image, a new image is obtained, by synthesizing processing the second synthesized image and the fourth base-exposure image, as a third synthesized image. The new synthesized images are sequentially taken as base images in the aforementioned manners, and the next base-exposure image is taken as the operation image, and the base image and the operation image are synthesizing processed until the last base-exposure image is also involved in the synthesizing process, and the last image, the synthesizing process of which involves the last base-exposure image, is taken as the long-time exposure image.

In the present embodiment, the capturing process of the base-exposure images and the synthesizing process of the base-exposure images are executed concurrently; or, the synthesizing process of the base-exposure images is executed after the capturing process of the base-exposure images is finished.

The capturing process of the base-exposure images and the synthesizing process of the base-exposure images are executed concurrently specifically means that: the synthesizing process of other base-exposure images, except for the first base-exposure image and the second base-exposure image, is that during the capturing process of the next base-exposure image, the preceding base-exposure image and the corresponding synthesized image or base-exposure image are being synthesizing processed. For example, during capturing the third base-time image, the first base-exposure image and the second base-exposure image are being synthesizing processed to form a first synthesized image; during capturing the fourth base-exposure image, the first synthesized image and the third base-exposure image are being synthesizing processed to form a second synthesized image. The instantaneity of the synthesized process of long-time exposure image is ensured by such an arrangement, however, the kernel resource of processor of the image capturing device is occupied increasingly.

After the capturing process of the base-exposure images are completed, execution of the synthesizing process of the base-exposure images specifically means that: all the base-time images are captured by the photographing device firstly, then all the base-time images are sequentially synthesizing processed in a superimposing manner. This arrangement reduces the stress of the processor of the image capturing device, but extends the synthesizing time of long-time exposure image.

According to technical solution of the present embodiment, through determining, based on the target exposure time and the hardware supporting exposure time, the number of the base-exposure images; capturing the number of the base-exposure images the number of which is greater than two, successively synthesizing processed, based on association relationships between blurriness of pixel points of corresponding positions of the base-exposure images, the base-exposure images in a superimposing manner to generate the long-time exposure image, it becomes possible that an image with long-time exposure effect is obtained by utilizing a device that supports short-time exposure, the hardware restriction, of photographing device, on image effect is reduced and the user's experience is improved.

FIG. 3 is schematic view showing the structure of a device for processing image according to embodiments of the present disclosure. The device for processing image according to the present embodiment may be arranged in an apparatus for supporting image capturing. As shown in FIG. 3, the device for processing image includes: a number determining module 310, an image capturing module 320 and an image generating module 330.

The number determining module 310 is configured to determine, based on a target exposure time and a hardware supporting exposure time, the number of base-exposure images for synthesizing a long-time exposure image.

The image capturing module 320 is configured to capture the number of base-exposure images according to the hardware supporting exposure time.

The image generating module 330 is configured to synthesizing process, based on association relationships of ambiguities of pixel points of corresponding positions in the base-exposure images, of the base-exposure images to generate a long-time exposure image corresponding to the target exposure time.

According to technical solution of the present embodiment, through determining, based on the target exposure time and the hardware supporting exposure time, the number of the base-exposure images; capturing the number of the base-exposure images the number of which is greater than two; successively synthesizing processing, based on association relationships of blurriness of pixel points of corresponding positions of the base-exposure images, of the base-exposure images in a superimposing manner to generate the long-time exposure image, it becomes possible that an image with long-time exposure effect is obtained by utilizing a device that supports short-time exposure, the hardware restriction, of photographing device, on image effect is reduced and the user's experience is improved.

In some embodiments, the number determining module 310 may include:

A time determining unit, which is configured to determine the target exposure time M according to an operation of a user;

A time acquiring unit, which is configured to acquire a maximum exposure time supported by hardware as the hardware supporting exposure time N;

A number calculating unit, which is configured to calculate the number k of base-exposure images according to a formula k=┌M/N┐, where, M>N, ┌•┐ represents a round-up operation.

In some embodiments, the image generating module 330 may include:

A base acquiring unit, which is configured to acquire the first captured base-exposure image as a base image;

An operation acquiring unit, which is configured to acquire, according to an order for obtaining the base-exposure images, a next base-exposure image of the base image as an operation image;

An image synthesizing unit, which is configured to synthesizing process, according to association relationships of ambiguities of pixel points of corresponding positions of the base image and the operation image, to obtain a new image;

An image determining unit, which is configured to utilize the synthesized image as a new base image and return to a procedure of acquiring the operation image until the synthesizing process of all base-exposure images are completed, and the newest updated base image is taken as the long-time exposure image.

In some embodiments, the image synthesizing unit is configured to:

sequentially scan the base image and the operation image and compare the ambiguities of respective pixel points having the same coordinates in the base image and the operation image;

if a difference between the ambiguities of the base image and the operation image which correspond to a same target coordinate position is less than or equal to a threshold value, the pixel point of the target coordinate position in the operation image is taken as the corresponding pixel point of the target coordinate position in the synthesized image;

if the difference between the ambiguities of the base image and the operation image which correspond to a same target coordinate position is greater than the threshold value, then a pixel point having a higher ambiguity as a corresponding pixel point of the target coordinate position in the synthesized image.

In some embodiments, the image generating module 330 may further include:

An concurrency synthesizing unit, which is configured to control the capturing process of the base-exposure images and the synthesizing process of the base-exposure images to be concurrently executed; or

A sequence synthesizing unit, which is configured to control the synthesizing process of the base-exposure images to be executed after the capturing process of the base-exposure images is finished.

The device for processing image according to the present embodiment and the method for processing image provided in any of embodiments of the present disclosure belong to a same inventive concept. The device for processing image according to the present embodiment can execute the method for processing image provided in any of embodiments of the present disclosure, and be provided with corresponding function modules and advantages. The technical details which are not disclosed in detail in the present embodiment can be referred to the process of processing image provided in any of embodiments of the present disclosure.

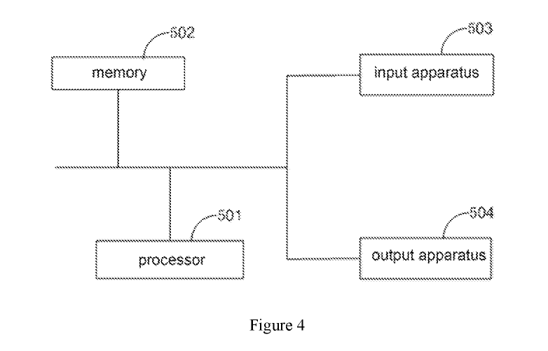

FIG. 4 is a schematic view of a hardware structure of an electronic device having image capturing function (such as a feature phone) according to embodiments of the present disclosure. As illustrated in FIG. 4, the feature phone includes:

One or more processors 501 and a memory 502, where exemplified in FIG. 4 is one processor 501.

The electronic device may further include: an input apparatus 503 and an output apparatus 504.

The processor 501, the memory 502, the input apparatus 503 and the output apparatus 504 in the feature phone may be connected by a bus or by any other means, and exemplified in FIG. 4 is a bus connection.

The memory 502, a non-volatile computer readable storage medium, may be used to store a non-volatile software program, a non-volatile computer executable program and modules, such as program instructions/modules (for example, a number determining module 310, an image capturing module 320 and an image generating module 330 as shown in FIG. 3) corresponding to the method for processing image in the embodiments of the present disclosure. The processor 501 executes various functional applications of a server and data processing by running the nonvolatile software program, the instructions and the modules which are stored in the memory 502, that is, the method for processing image is realized.

The memory 502 may include a program storage area and a data storage area, where the program storage area may store an operating system, and applications required by at least one function; the data storage area may store data and the like created according to the use of the image white balance calibration method. In addition, the memory 502 may include a high-speed random access memory, and may further include a non-volatile memory. For example, at least one magnetic disk memory device, a flash device, or other nonvolatile solid-state memory devices. In some embodiments, the memory 502 optionally includes memories remotely disposed relative to the processor 501.

The input apparatus 503 may be used to receive input digital or character information, as well as a key signal input related to user settings and function control. The output apparatus 504 may include display devices such as a display screen.

The one or more modules are stored in the memory 502, and perform the method for processing image any of the above method embodiments when being executed by the one or more processors 501.

Embodiments of the present disclosure further provide a non-volatile storage medium, which stores a computer executable instruction, where the computer executable instruction is configured to perform the method for processing image in any one of the embodiments of the present disclosure.

The aforementioned product can execute the method according to embodiments of the present disclosure, and be provided with corresponding function modules to execute the method and benefits. Regarding technical details not disclosed in detail, please referring to the process of processing image in any embodiment of the present disclosure.

The electronic device in embodiments of this application exists in various forms, including but not limited to:

(1) mobile telecommunication device. A device of this kind has a feature of mobile communicating function, and has a main object of providing voice and data communication. Devices of this kind include smart phone (such as IPHONE), multi-media cell phone, functional cell phone, low-end cell phone and the like;

(2) ultra mobile personal computer device. A device of this kind belongs to a category of personal computer, has functions of computing and processing, and generally has a feature of mobile interne access. Devices of this kind include PDA, MID, UMPC devices and the like, such as IPAD;

(3) portable entertainment device. A device of this kind can display and play multi-media content. Devices of this kind include audio and video player (such as IPOD), handheld game player, e-book, intelligent toy and portable vehicle navigation device;

(4) server, which is a device providing computing services. Construction of a server includes a processor, a hard disk, a memory, a system bus and the like. The server is similar to a common computer in architecture, but has high requirements in aspects of processing capacity, stability, reliability, security, expandability, manageability and the like since services of high reliability are needed to be provided;

(5) other electronic devices having data interacting functions.

Device embodiments described above are only illustrative, elements in the device embodiments illustrated as separated components may be or may not be physically separated, and components shown as elements may be or may not be physical elements, that is, the components may be located in one position, or may be distributed on a plurality of network units. Part or all of modules in the components may be selected according to actual requirements to achieve purpose of solutions in embodiments, which can be understood and perform by those of ordinary skill in the art without inventive works.

By descriptions of above embodiments, those skilled in the art can clearly learn that various embodiments can be achieved with aid of software and necessary common hardware platform, or with aid of hardware. Based on such an understanding, essential of above technical solutions or, in other words, parts of above technical solutions contributing to the related art may be embodied in form of software products which can be stored in a computer readable storage medium, such as a ROM/RAM, a disk, an optical disk and the like, and include a number of instructions configured to make a computer device (may be a personal computer, server, network device and the like) execute methods of various embodiments or parts of embodiments.

Finally, it should be noted that above embodiments are only used for illustrating but not to limit technical solutions of the present disclosure; although the present disclosure is described in detail with reference to the foregoing embodiments, those of ordinary skill in the art should understand that technical solutions recorded in the foregoing embodiments can be modified, or parts of the technical solutions can be equally replaced; and the modification and replacement does not make essential of corresponding technical solutions depart from spirits and scope of technical solutions of various embodiments.

What is claimed is:

1. A method for processing image, applied to an electronic device, the method comprising:
determining, based on a target exposure time and a hardware supporting exposure time, a number of base-exposure images for synthesizing a long-time exposure image;
capturing the number of base-exposure images according to the hardware supporting exposure time; and
synthesizing processing, based on association relationships of ambiguities of pixel points of corresponding positions of the base-exposure images, of the base-exposure images to generate the long-time exposure image corresponding to the target exposure time.

2. The method of claim 1, wherein determining, based on a target exposure time and a hardware supporting exposure time, a number of base-exposure images for synthesizing a long-time exposure image comprises:
determining the target exposure time M based on operation of a user;
acquiring a maximum exposure time supported by hardware as the hardware supporting exposure time N; and
determining, based on a formula k=┌M/N┐, the number k of the base-exposure images for synthesizing the long-time exposure image, where M>N, and ┌•┐ represents a round-up operation.

3. The method of claim 1, wherein synthesizing processing, based on association relationships of ambiguities of pixel points of corresponding positions of the base-exposure images, of the base-exposure images to generate the long-time exposure image corresponding to the target exposure time comprises:
acquiring a first captured base-exposure image of the base-exposure images as a base image;
acquiring a next base-exposure image of the base image according to an order for capturing the base-exposure images as an operation image;
synthesizing, according to association relationships of ambiguities of pixel points of corresponding positions of the base image and the operation image, a new image; and
utilizing the synthesized image as a new base image and returning to a procedure of acquiring the operation image until synthesizing process of all base-exposure images are completed, and taking the newest updated base image as the long-time exposure image.

4. The method of claim 3, wherein synthesizing, according to association relationships of ambiguities of pixel points of corresponding positions of the base image and the operation image, a new image comprises:
sequentially scanning the base image and the operation image, and comparing ambiguities of respective pixel points having the same coordinates in the base image and the operation image;
if a difference between the ambiguities of the base image and the operation image which correspond to a same target coordinate position is less than or equal to a threshold value, taking a pixel point of the target coordinate position in the operation image as a corresponding pixel point of the target coordinate position in the synthesized image; and
if the difference between the ambiguities of the base image and the operation image which correspond to a same target coordinate position is greater than the threshold value, taking a pixel point having a higher ambiguity as a corresponding pixel point of the target coordinate position in the synthesized image.

5. The method of claim 3, wherein a capturing processing of the base-exposure images and a synthesizing processing of the base-exposure images are executed concurrently; or
the synthesizing processing of the base-exposure images is executed after the capturing processing of the base-exposure images is finished.

6. The method of claim 2, wherein synthesizing processing, based on association relationships of ambiguities of pixel points of corresponding positions of the base-exposure images, the base-exposure images to generate the long-time exposure image corresponding to the target exposure time comprises:
acquiring a first captured base-exposure image of the base-exposure images as a base image;
acquiring a next base-exposure image of the base image according to an order for capturing the base-exposure images as an operation image;
synthesizing, according to association relationships of ambiguities of pixel points of corresponding positions of the base image and the operation image, a new image; and
utilizing the synthesized image as a new base image and returning to a procedure of acquiring the operation image until synthesizing processing of all base-exposure images are completed, and taking the newest updated the base image as the long-time exposure image.

7. The method of claim 6, wherein synthesizing, according to association relationships of ambiguities of pixel points of corresponding positions of the base image and the operation image, a new image comprises:
sequentially scanning the base image and the operation image, and comparing ambiguities of respective pixel points having the same coordinates in the base image and the operation image;
if a difference between the ambiguities of the base image and the operation image which correspond to a same target coordinate position is less than or equal to a threshold value, taking a pixel point of the target coordinate position in the operation image as a corresponding pixel point of the target coordinate position in the synthesized image; and
if the difference between the ambiguities of the base image and the operation image which correspond to a same target coordinate position is greater than the threshold value, taking a pixel point having a higher ambiguity as a corresponding pixel point of the target coordinate position in the synthesized image.

8. The method of claim 6, wherein a capturing processing of the base-exposure images and a synthesizing processing of the base-exposure images are executed concurrently; or
the synthesizing processing of the base-exposure images is executed after the capturing processing of the base-exposure images is finished.

9. An electronic device for processing image, comprising: at least one processor; and a memory communicably connected with the at least one processor for storing instructions executable by the at least one processor, wherein execution of the instructions by the at least one processor causes the at least one processor to perform:
determining, based on a target exposure time and a hardware supporting exposure time, a number of base-exposure images for synthesizing a long-time exposure image;
capturing at least two base-exposure images according to the hardware supporting exposure time; and
synthesizing processing, based on association relationships of ambiguities of pixel points of corresponding positions of the base-exposure images, of the base-exposure images to generate the long-time exposure image corresponding to the target exposure time.

10. The electronic device of claim 9, wherein when determining, based on a target exposure time and a hardware supporting exposure time, a number of base-exposure images for synthesizing a long-time exposure image, the at least one processor performs:
determining the target exposure time M based on operation of a user;
acquiring a maximum exposure time supported by hardware as the hardware supporting exposure time N; and
determining, based on a formula k=┌M/N┐, the number k of the base-exposure images for synthesizing the long-time exposure image, where M>N, and ┌•┐ represents a round-up operation.

11. The electronic device of claim 9, wherein when synthesizing processing, based on association relationships of ambiguities of pixel points of corresponding positions of the base-exposure images, the base-exposure images to generate the long-time exposure image corresponding to the target exposure time, the at least one processor performs:
acquiring a first captured base-exposure image of the base-exposure images as a base image;
acquiring a next base-exposure image of the base image according to an order for capturing the base-exposure images as an operation image;
synthesizing, according to association relationships of ambiguities of pixel points of corresponding positions of the base image and the operation image, a new image; and
utilizing the synthesized image as a new base image and returning to a procedure of acquiring the operation image until synthesizing processing of all base-exposure images are completed, and taking the newest updated base image as the long-time exposure image.

12. The electronic device of claim 11, wherein when synthesizing, according to association relationships of ambiguities of pixel points of corresponding positions of the base image and the operation image, a new image, the at least one processor performs:
sequentially scanning the base image and the operation image, and comparing ambiguities of respective pixel points having the same coordinates in the base image and the operation image;
if a difference between the ambiguities of the base image and the operation image which correspond to a same target coordinate position is less than or equal to a threshold value, taking a pixel point, of the target coordinate position, in the operation image as a corresponding pixel point, of the target coordinate position, in the synthesized image; and
if the difference between the ambiguities of the base image and the operation image which correspond to a same coordinate target position is greater than the threshold value, taking a pixel point having a higher ambiguities as a corresponding pixel point, of the target coordinate position, in the synthesized image.

13. The electronic device of claim 11, wherein when synthesizing processing, based on association relationships of ambiguities of pixel points of corresponding positions of the base-exposure images, of the base-exposure images to generate the long-time exposure image corresponding to the target exposure time, the at least one processor performs:
controlling a capturing processing of the base-exposure images and a synthesizing processing of the base-exposure images to be executed concurrently; or
controlling the synthesizing processing of the base-exposure images to be executed after the capturing processing of the base-exposure images is finished.

14. The electronic device of claim 10, wherein when synthesizing processing, based on association relationships of ambiguities of pixel points of corresponding positions of the base-exposure images, the base-exposure images to generate the long-time exposure image corresponding to the target exposure time, the at least one processor performs:
acquiring a first captured base-exposure image of the base-exposure images as a base image;
acquiring a next base-exposure image of the base image according to an order for capturing the base-exposure images as an operation image;
synthesizing, according to association relationships of ambiguities of pixel points of corresponding positions of the base image and the operation image, a new image; and
utilizing the synthesized image as a new base image and returning to a procedure of acquiring the operation image until synthesizing processing of all base-exposure images are completed, and taking the newest updated base image as the long-time exposure image.

15. The electronic device of claim 14, wherein when synthesizing, according to association relationships of ambiguities of pixel points of corresponding positions of the base image and the operation image, a new image, the at least one processor performs:
sequentially scanning the base image and the operation image, and comparing ambiguities of respective pixel points having the same coordinates in the base image and the operation image;
if a difference between the ambiguities of the base image and the operation image which correspond to a same target coordinate position is less than or equal to a threshold value, taking a pixel point, of the target coordinate position, in the operation image as a corresponding pixel point, of the target coordinate position, in the synthesized image; and
if the difference between the ambiguities of the base image and the operation image which correspond to a same coordinate target position is greater than the threshold value, taking a pixel point having a higher ambiguities as a corresponding pixel point, of the target coordinate position, in the synthesized image.

16. The electronic device of claim 14, wherein when synthesizing processing, based on association relationships of ambiguities of pixel points of corresponding positions of the base-exposure images, the base-exposure images to generate the long-time exposure image corresponding to the target exposure time, the at least one processor performs:
controlling a capturing processing of the base-exposure images and a synthesizing processing of the base-exposure images to be executed concurrently; or
controlling the synthesizing processing of the base-exposure images to be executed after the capturing process of the base-exposure images is finished.

17. A non-volatile computer-readable storage medium storing executable instructions that, when executed by an electronic device, cause the electronic device to perform:
determining, based on a target exposure time and a hardware supporting exposure time, a number of base-exposure images for synthesizing a long-time exposure image;
capturing the number of base-exposure images according to the hardware supporting exposure time; and
synthesizing processing, based on association relationships of ambiguities of pixel points of corresponding positions of the base-exposure images, of the base-exposure images to generate the long-time exposure image corresponding to the target exposure time.

18. The computer-readable storage medium of claim 17, wherein determining, based on a target exposure time and a hardware supporting exposure time, a number of base-exposure images for synthesizing a long-time exposure image comprises:
determining the target exposure time M based on operation of a user;
acquiring a maximum exposure time supported by hardware as the hardware supporting exposure time N; and
determining, based on a formula k=┌M/N┐, the number k of the base-exposure images for synthesizing the long-time exposure image, where M>N, and ┌•┐ represents a round-up operation.

19. The computer-readable storage medium of claim 17, wherein synthesizing processing, based on association relationships of ambiguities of pixel points of corresponding positions of the base-exposure images, of the base-exposure images to generate the long-time exposure image corresponding to the target exposure time comprises:
acquiring a first captured base-exposure image of the base-exposure images as a base image;
acquiring a next base-exposure image of the base image according to an order for capturing the base-exposure images as an operation image;
synthesizing, according to association relationships of ambiguities of pixel points of corresponding positions of the reference image and the operation image, a new image; and
utilizing the synthesized image as a new base image and returning to a procedure of acquiring the operation image until synthesizing processing of all base-exposure images are completed, and taking the newest updated the base image as the long-time exposure image.

20. The computer-readable storage medium of claim 17, wherein synthesizing, according to association relationships of ambiguities of pixel points of corresponding positions of the base image and the operation image, a new image comprises:
sequentially scanning the base image and the operation image, and comparing ambiguities of respective pixel points having the same coordinates in the base image and the operation image;
if a difference between the ambiguities of the base image and the operation image which correspond to a same target coordinate position is less than or equal to a threshold value, taking a pixel point, of the target coordinate position, in the operation image as a corresponding pixel point, of the target coordinate position, in the synthesized image; and
if the difference between the ambiguities of the base image and the operation image which correspond to a same coordinate target position is greater than the threshold value, taking a pixel point having a higher ambiguities as a corresponding pixel point, of the target coordinate position, in the synthesized image.
